(19) United States
(12) Patent Application Publication
(10) Pub. No.: US 2014/0071010 A1
(43) Pub. Date: Mar. 13, 2014

(54) RADIO FREQUENCY FEED BLOCK FOR MULTI-BEAM ARCHITECTURE

(71) Applicant: THALES, Neuilly-sur-Seine (FR)

(72) Inventors: Stephane POUYEZ, Toulouse (FR); Michael POTIER, Toulouse (FR); Jean-Luc BOUGUEREAU, PLAISANCE DU TOUCH (FR); Pierre BOSSHARD, TOURNEFEUILLE (FR); Alain GERARD, TOULOUSE (FR)

(73) Assignee: THALES, Neuilly-sur-Seine (FR)

(21) Appl. No.: 14/020,602

(22) Filed: Sep. 6, 2013

(30) Foreign Application Priority Data
Sep. 7, 2012 (FR) 12 02394

(51) Int. Cl. H01Q 13/02

(52) U.S. Cl. CPC H01Q 13/02
USPC 343/779

(57) ABSTRACT

In the field of satellite communications and more particularly to a multi-beam antenna system for the coverage of a given geographical region broken down into several spots on the ground, a radio frequency feed block comprises several radio frequency chains intended to transmit or to receive an electromagnetic wave in the direction of a reflector and waveguides connected to outputs of the chains, characterized in that it comprises a plate inside which the waveguides are made, and to which the radio frequency chains are fastened. A satellite comprising a feed block is also provided.

### CROSS-REFERENCE TO RELATED APPLICATION

This application claims priority to foreign French patent application No. FR 1202394, filed on Sep. 7, 2012, the disclosure of which is incorporated by reference in its entirety.

### FIELD OF THE INVENTION

The invention lies within the field of satellite communications and more specifically concerns multi-spot antennas (multiple feeds) in front of a reflector). The general architecture of these multi-spot antennas leads to a particularly complicated definition and layout on the satellite: the layout of a large number of spots constituting the telecommunications mission, as well as the suite of associated functions: radio frequency (RF), mechanical, thermal, interfaces with a payload and the satellite.

### BACKGROUND

Generally the architecture of multi-spot feeds is based on the fact that RF chains constitute the heart of the architecture. “RF chain” is understood to mean an assembly composed of a horn and RF components making it possible to switch from a guided mode of propagation of the electromagnetic waves to a radiative mode. RF chains are generally designed upstream and independently of the layout.

Additional functions are successively added:

a primary structure enabling the orientation and fastening of the RF chains and the interface with the satellite,

an RF harness composed of discrete waveguides making it possible to ensure the interface with the payload, to which is joined the mechanical support for the waveguides on the primary structure of the satellite,

passive and/or active thermal control, enabling heating or cooling, is added to keep the assembly within the qualification temperature ranges for each element.

In order to ensure the mission relating to the spot localization, the mechanical fastenings of the RF chains and of the feed block must provide:

a specific orientation of each RF chain towards the reflector, which typically causes angular variations of the RF chains in relation to the aperture midplane.

a stability of orientation under thermo-mechanical loads, taking into consideration the compatibility between materials and the temperature gradients that may come into play between the different fastening plates ensuring the mounting of the RF chains; an example embodiment of an architecture of a multi-spot feed using these techniques is given in the patent application published under n° WO 2009/115407;

a sufficiently stiff and effective hold of the RF chains;

an overall mechanical behaviour compatible with the satellite specifications.

To meet these constraints, RF chains are not structural and only meet the RF requirement.

The RF chains are held along their length in two or three areas by metallic plates and require the use of intermediate parts ensuring the function of thermo-mechanical decoupling.

The overall structure of the feed block is based on the use of multiple structural plates.

As a result:

the congestion of the primary structure of the satellite is potentially critical with respect to the layout of the satellite,

the large number of parts entails a great complexity of design and assembly,

the highly compartmentalized structure entails a corrupted thermal view factor in the Space direction for the central RF chains, which cannot dissipate their thermal energy,

the mass becomes large.

For wide-coverage multi-spots on the terrestrial globe, the large size of the feed block requires all the RF accesses to be brought to a relatively small distance from the installation surface of the feed block so that these accesses are connected to the payload repeater. This constraint is related to the relative flexibility of the guides and thus to the need to support them.

Generally there are as many specific guides as there are RF accesses (from one to six accesses per RF chain) to recover the specific pointing angles of the RF chains. This results in as many specific guides and guide supports to design depending on the distribution of the spots and the RF interfaces.

The implementation of these existing concepts is complicated and unsatisfactory in terms of compromise between performance, cost, bulk and mass. The main drawbacks are as follows:

Routing as close as possible to the structural areas.

Complexity due to the shortest path constraint for optimization of the RF losses associated with constraints of constant length between chains and thermal gradients.

Manufacturability constraint of the guides (radii, number of bends, controls etc).

Accessibility and assembly problems.

The waveguides and their associated supports are specifically designed and dimensioned iteratively to meet a need for a stiffness/flexibility compromise imposed by vibratory and acoustic stresses on the one hand and thermo-mechanical stresses on the other. This design is furthermore very sensitive to changes in the boundary conditions due to the flexibility of the guides.

Brazed waveguides are often on the critical path in the planning of the manufacture of the feed block.

RF chains and RF harnesses are by nature dissipative elements. By design the generally observed architectures of multi-spot feed blocks do not enable central RF chains endowed with a poor view factor in the direction of Space to dissipate their energy by radiation. The admissible RF power is then directly connected to their ability to evacuate their energy by conduction.

To fulfil this function and improve the conductive links, multi-spot solutions rely on various stratagems such as:

choice of materials,

increase of wall thicknesses to the detriment of mass,

increase in the number and size of screw connections, since they are insulating by nature,

intermittent use of additional parts acting as thermal bridges.

The thermal performance connected with these stratagems is onerous in implementation terms and necessarily limited.

### SUMMARY OF THE INVENTION

The invention aims to palliate all or part of the abovementioned problems by providing a solution based around a central component incorporating all the functions of routing of the waveguides, of the supporting structure, of the positioning and orientation of the radio frequency chains and fulfilling, by virtue of its design, a heat exchanger role.

It is an object of the present invention to provide a radio frequency feed block for multi-beam architecture, the block comprising several radio frequency chains intended to transmit or receive an electromagnetic wave in the direction of a reflector and waveguides connected to outputs of the radio frequency chains, characterized in that it comprises a plate inside which the waveguides are made, and to which the radio frequency chains are fastened.

t is a further object of the present invention to provide a satellite comprising a feed block according to the invention, characterized in that the plate makes it possible to radiate thermal energy resulting from losses during the operation of the feed block.

### BRIEF DESCRIPTION OF THE DRAWING

The invention will be better understood and other advantages will become apparent on reading the detailed description of an embodiment given by way of example, a description illustrated by the attached drawing in which:

FIG. 1 shows a profile of a feed block according to the invention;

FIG. 2 shows the feed block of FIG. 1 in perspective;

FIG. 3 shows a section of a plate of the feed block;

FIG. 4 shows the detail of a transition made in the plate of the feed block.

For the sake of clarity, the same elements will bear the same reference numbers in the various figures.

### DETAILED DESCRIPTION

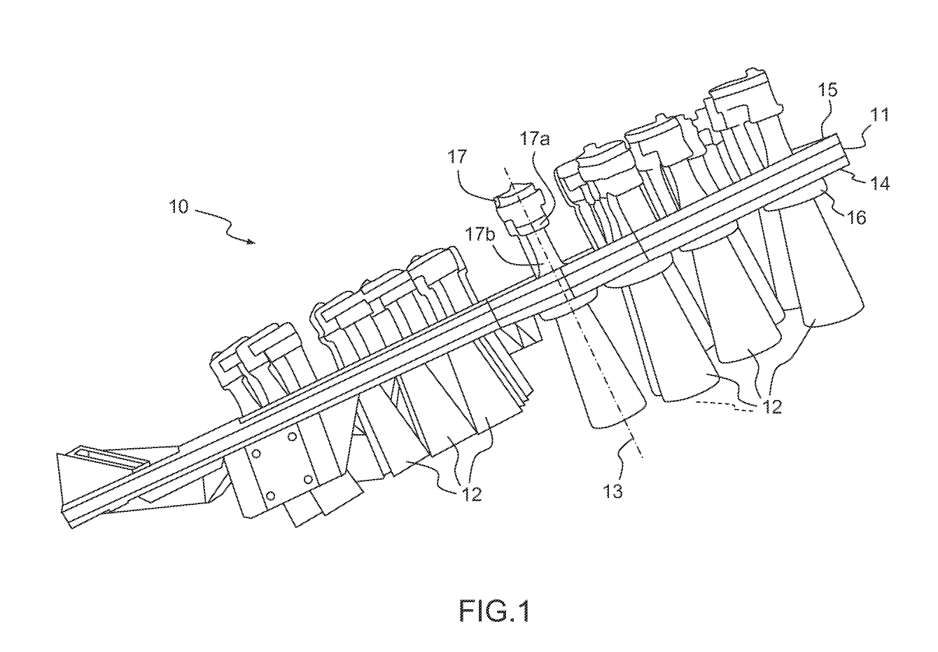

FIG. 1 shows a feed block 10 for a multi-beam architecture, the feed block 10 being intended for mounting on board a satellite. This type of architecture comprises a reflector and several radio frequency chains intended to each transmit and/or receive an electromagnetic wave in the direction of the reflector in order to ensure coverage of a given geographical region decomposed into several spots on the ground, each of the spots being associated with one of the radio frequency chains. The reflector is not shown to avoid overcrowding FIG. 1.

Each of the radio frequency chains contains one or more RF outputs each attached to a waveguide. According to the invention, the feed block comprises a plate 11 inside which the waveguides are made, and to which the radio frequency chains are fastened. The radio frequency chains 17 are separate from the plate 11 and are fastened to it. The plate 11 and the radio frequency chains form the feed block 10. In the example shown, in FIG. 1, each radio frequency chain comprises a horn 12 fastened to the plate 11. Each of the horns 12 is oriented around a main direction 13 depicted on one of the horns in FIG. 1. The direction 13 is substantially perpendicular to the plate 11 and is oriented towards the reflector and generally towards its centre. In the example shown, the horns 12 are fed through the plate 11. They extend from one side of the plate 11 to the other in the direction 13. This layout allows a projection of the horns 12 with respect to the plate 11 in the direction of the reflector that is less than the total length of the horns 12 measured in their direction 13. By convention the face of the plate 11 oriented towards the reflector will be called the front face 14 and the opposite face will be called the back face 15.

Each horn 12 includes a collar 16 made on its exterior surface and enabling the positioning of the horn 12 on the plate 11. In the example shown, the collar 16 presses against the front face 14. By way of alternative, it is also possible to press the horn 12 onto the back face 15 of the plate 11. The fastening of the collar 16 against the front face 14 may be achieved using screws or any other method of fastening, dismountable or otherwise, such as soldering or bonding. Advantageously the fastening means are dismountable in order to allow the testing and adjustment of the radio frequency chains.

It is of course possible to position the horns 12 in such a way that they extend only on one side of the plate 11.

Each radio frequency chain comprises, associated with each of the horns 12, an assembly 17 of transmission/reception (Tx/Rx) components having one or more radio frequency outputs 17a, typically from one to six outputs. Advantageously the feed block 10 comprises flexible waveguides 17b making it possible to connect the waveguides made inside the plate 11 and the outputs 17a of the radio frequency chains 17 and to thus manage the slight angular variations (typically of the order of +/−8°) of the horns 12 around the direction 13.

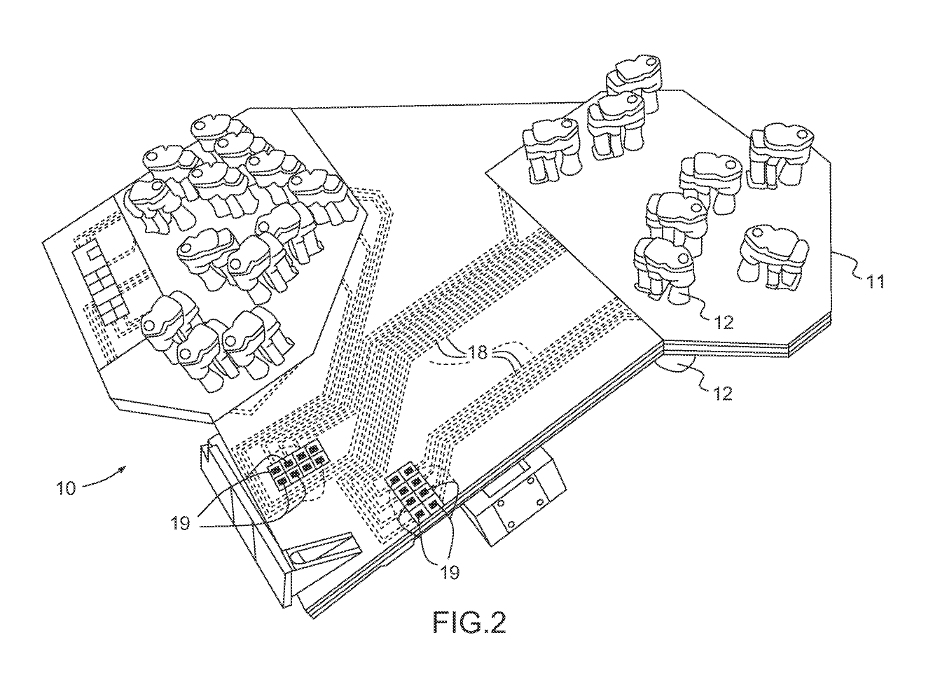

FIG. 2 shows in perspective the feed block 10 of FIG. 1. In FIG. 2, dotted lines indicate the path of the various waveguides 18 found inside the plate 11. A waveguide 18 links an assembly 17 and a flange 19, which allows the connection of the radio frequency chain under consideration to the corresponding RF interface of the payload. In other words, each of the waveguides 18 connects one of the radio frequency outputs 17a and one of the flanges 19. Each of the waveguides 18 has only two ends, one connected to a radio frequency output 17a and the other to a flange 19. The items of payload equipment can interface directly with each other on the plate 11 at the level of the flanges 19 or remotely via waveguides. The use of the plate 11 makes it possible to group together the flanges 19 depending on the payload installation constraints. In the case where the items of payload equipment are connected to the plate 11 by waveguides, the implementation of the plate 11 makes it possible to simplify the routing of these waveguides.

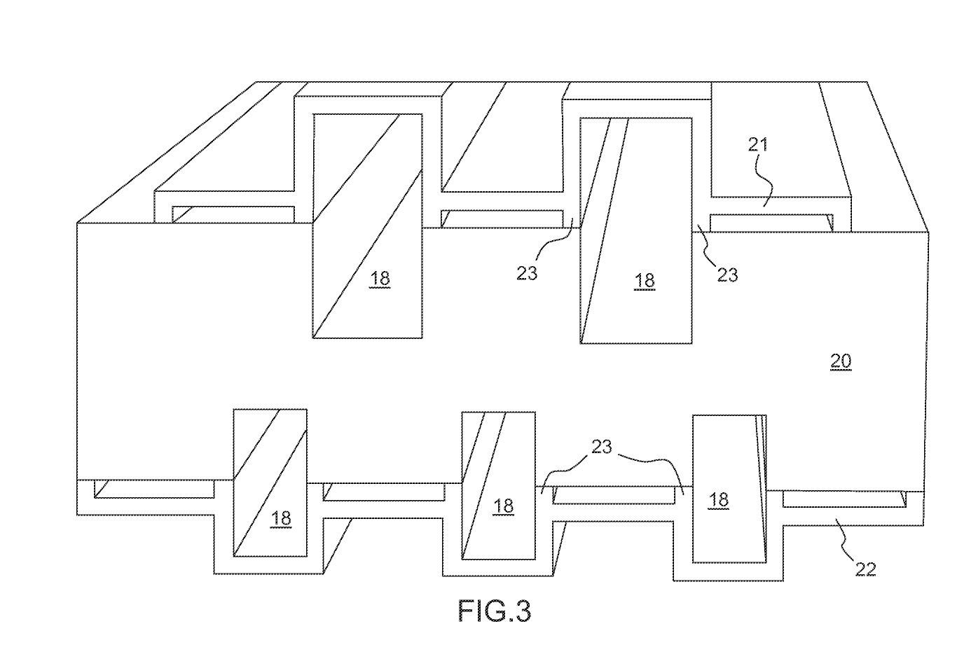

FIG. 3 shows a section of the plate 11. This figure makes it possible to illustrate an embodiment of the waveguides 18 in the plate 11. The plate 11 comprises a core 20 forming the supporting structure of the plate 11. The core 20 extends over the whole surface of the plate 11. The core 20 is for example made from machined aluminium alloy. Other materials are of course possible. It is possible for example to choose from among metallic or composite materials. The material and its sizing are defined for its mechanical qualities, making it possible to ensure the stiffness of the feed block as a whole as well as its dimensional stability, particularly in the event of variations in temperature. The definition of the core 20 also depends on the heat exchanges that the plate 11 must ensure with the outside environment.

More precisely, heat losses occur in the RF chains and the waveguides when the feed block is operating 10. On board of a satellite, these losses may only be evacuated by radiation or conduction. The satellite accommodation may be defined in such a way that one of the faces of the plate 11 has a free view of space or of the satellite surroundings. Generally the front face 14 on which the horns 12 are mounted is not significantly masked by other elements of the satellite and allows good heat exchange with the outside environment. Thanks to the incorporation of the waveguides 18 inside the plate 11, the back face 15 opens towards a less obstructed volume of the satellite, thus improving the possibility of thermal radiation from this face. In addition, the back face 15 is less liable to be subject to solar radiation thus allowing it to radiate heat in a more constant manner, whether or not the satellite is lit by the Sun.

Generally, where heat dissipation is concerned, the fact of employing a plate 11 inside which the waveguides 18 are made makes it possible to perform in the same mechanical part the function of conducting the heat emitted by the electromagnetic radiation at the walls of the various waveguides towards the exterior faces of the plate 11, as well as the function of dissipation by radiation at these exterior walls, which makes it possible to improve the thermal behaviour of the feed block 10. The fact of using a single mechanical part (the plate 11) shared by several waveguides makes it possible to homogenize the temperature of the plate 11 and thus to improve the heat dissipation by the exterior faces. Unlike the prior art, the walls of the waveguides are, in the invention, formed of one bulky piece, which improves its heat conduction. Even if only some of the waveguides are used, the conduction inside the plate 11 makes it possible to make use of the whole surface area of the exterior faces to cool the block feed 10. If the heat dissipation need increases, the availability of a flat plate 11 makes it possible to easily fasten cooling means to it, such as for example heat pipes, which make it possible to evacuate heat towards offset heat dissipators.

The plate 11 comprises at least one lid, and for example two lids 21 and 22 as shown in FIG. 2. The waveguides are formed by grooves made between the core 20 and each of the lids 21 and 22. The grooves are for example machined in the core 20 only. The lid is then flat and closes the groove. It is also possible to machine part of the waveguides in the core 20 and part in the associated lid 21 or 22. The lids may cover the whole core 20 over the whole surface of the plate 11. It is also possible to cover only the surfaces of the plate 11 that are occupied by the waveguides 18. An associated lid may be provided for each of the waveguides 18. But advantageously, a lid is shared by several waveguides. For a given face of the plate 11, to reduce the number of mechanical parts to assemble, a single lid may be provided per face of the plate 11, this lid then covering all the waveguides made on this face. The advantage of this so-called E-plane section system is that it is, by design, better adapted to limiting the effects of passive intermodulation (PIM).

The fact of making the waveguides 18 on the two faces 15 and 16 of the plate 11 allows waveguide crossovers to be made. These crossovers are useful because they are more compliant with the localization constraints of the RF interfaces in the direction of the payload, thus simplifying the connection between the plate 11 and the payloads. The plate 11 advantageously comprises at least one transition 25 crossing the core 20 and connecting waveguides 18 made by means of the two lids 20 and 21.

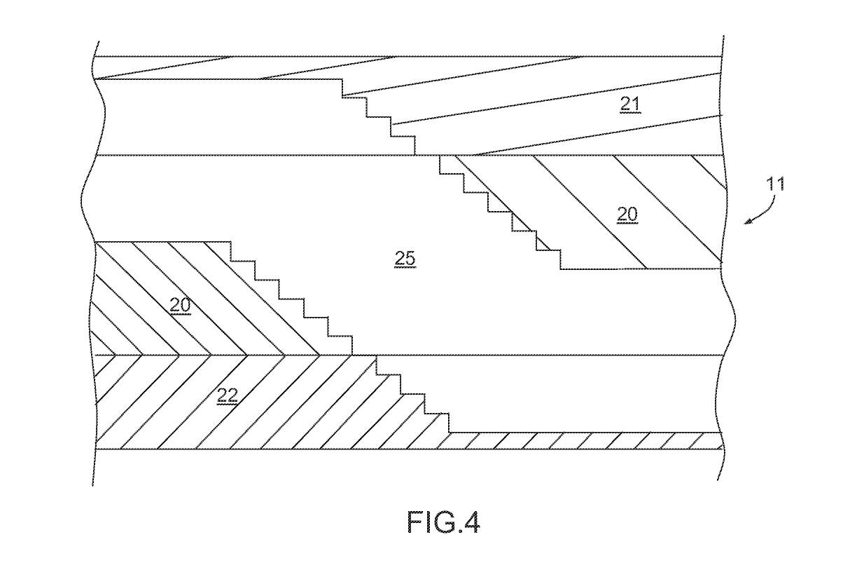

FIG. 4 shows an example of transition 25 made by means of inclined sides made in the lids 21 and 22 as well as in the core 20. The inclined sides make it possible to modify the direction of propagation of an electromagnetic wave in the waveguide so that it passes from one face to the other of the plate 11. To facilitate the manufacturing of the transition 25, for example by machining, the inclined sides may be replaced by steps to form stairs as shown in FIG. 4.

The lids 21 and 22 are made from an electrically conductive material so that they can be used as walls for the waveguides 18. Moreover, in order to promote thermal radiation, a material will be chosen with the highest emissivity possible. It is for example possible to make the lids from an aluminium alloy that has been surface treated to improve its emissivity. Other materials such as carbon-fibre composites embedded in resin may also be employed. Advantageously, the core 20 and the lids 21 and 22 are made of the same material so that they possess the same mechanical characteristics, notably in terms of thermal behaviour.

In order to ensure tight sealing of the waveguides 18 so as to limit wave leakage, contact between lid and core may be ensured locally by means of edges 23 arranged at the level of the wall of each of the waveguides 18. The edges 23 make it possible to reduce the contact surface between lid and plate and consequently to increase the contact pressure. A slight deformation of the lids 21 and 22 is thus obtained when they are fastened to the core 20. This deformation makes it possible to better hold the surfaces in contact and therefore to reduce possible gaps between plate and lid. In this way electromagnetic leakage and the PIM effects at the interface between the core 20 and each of the lids 21 and 22 are limited.

1. A radio frequency feed block for multi-beam architecture, the block comprising several radio frequency chains intended to transmit or receive an electromagnetic wave in the direction of a reflector, each of the radio frequency chains comprising one or more outputs, waveguides each connected to one of the outputs of the radio frequency chains, and a plate inside which the waveguides are made, and to which the radio frequency chains are fastened.

2. The feed block according to claim 1, wherein the plate comprises flanges enabling the connection of the waveguides towards the repeater of a payload.

3. The feed block according to claim 2, wherein each radiofrequency chain comprises, an assembly of transmitting/receiving components having one of more radio frequency outputs and wherein each of the waveguides links one of the radio frequency outputs and one of the flanges.

4. The feed block according claim 1, wherein the radio frequency chains are separate from the plate and are fastened to it.

5. The feed block according to claim 1, wherein each radio frequency chain comprises a horn fastened to the plate.

6. The feed block according to claim 1, further comprising flexible waveguides making it possible to connect the waveguides made inside the plate and the outputs of the radio frequency chains.

7. The feed block according to claim 1, wherein the plate comprises a core and at least one lid between which grooves forming the waveguides are made.

8. The feed block according to claim 7, wherein the plate comprises two lids each forming an opposing face of the plate, and wherein grooves forming waveguides are made between the core and each of the lids.

9. The feed block according to claim 8, wherein the core and the lids are made of the same material.

10. The feed block according to claim 8, wherein the plate comprises at least one transition crossing the core and connecting waveguides made by means of two lids.

11. A satellite comprising a feed block according to claim 1, wherein the plate makes it possible to radiate thermal energy resulting from losses during the operation of the feed block.
